(19) United States
(12) Patent Application Publication
(10) Pub. No.: US 2021/0371654 A1
(43) Pub. Date: Dec. 2, 2021

(54) Thermoplastic Resin Composition and Molded Product Manufactured Therefrom

(71) Applicant: LOTTE CHEMICAL CORPORATION, Seoul (KR)

(72) Inventors: Seung Yong BAE, Uiwang-si (KR); Yoen Kyoung KIM, Uiwang-si (KR); Ju Sung KIM, Uiwang-si (KR); Cheon Seok YANG, Uiwang-si (KR)

(21) Appl. No.: 16/757,492

(22) PCT Filed: Dec. 18, 2018
(86) PCT No.: PCT/KR2018/016158

§ 371 Date: Apr. 20, 2020

(30) Foreign Application Priority Data
Dec. 26, 2017 (KR) 10-2017-0179228
Nov. 19, 2018 (KR) 10-2018-0142400

(51) Int. Cl. C08L 77/10; C08L 67/03; C08G 63/183; C08G 63/189; A01N 59/00

(52) U.S. Cl. CPC C08L 77/10; C08L 67/03; C08L 77/02; C08G 63/189; A01N 59/00; C08G 63/183

(57) ABSTRACT

A thermoplastic resin composition of the present invention comprises: about 100 parts by weight of a thermoplastic resin containing at least one of a polyamide resin and a polyester resin; and about 1 to about 5 parts by weight of zinc oxide, wherein the zinc oxide has an average particle size (D50), as measured by a particle analyzer, of about 0.8 to about 3 μm, and wherein the intensity ratio (B/A) of peak A in a region of 370-390 nm and peak B in a range of 450-600 nm, at the time of photoluminescence measurement, is about 0.01 to about 1.0. The thermoplastic resin composition is excellent in weather resistance, antibacterial properties, mechanical properties, and the like.

### TECHNICAL FIELD

The present invention relates to a thermoplastic resin composition and a molded product manufactured therefrom. More particularly, the present invention relates to a thermoplastic resin composition which has good weather resistance, antibacterial properties, and mechanical properties, and a molded product manufactured therefrom.

### BACKGROUND ART

Recently, with increasing interest in personal health and hygiene and increasing income level, there is increasing demand for thermoplastic resin products having antibacterial and hygienic functions. Accordingly, there is an increasing number of thermoplastic resin products subjected to antibacterial treatment to remove or inhibit bacterial growth on surfaces of household goods and electronic products. Therefore, development of a functional antibacterial material having stability and reliability (an antibacterial thermoplastic resin composition) is a very important challenge. In addition, with increasing interest in personal hygiene and beauty, there is increasing demand for oral hygiene products and beauty equipment, and the adoption of antibacterial materials, such as brushes with antibacterial bristles (antibacterial fiber) is increasing in the art.

In order to prepare such an antibacterial thermoplastic resin composition, it is necessary to add antibacterial agents. Such antibacterial agents may be divided into organic antibacterial agents and inorganic antibacterial agents.

Organic antibacterial agents are sometimes toxic to humans, are effective only against certain bacteria, and are likely to decompose and lose antibacterial properties upon processing at high temperature, despite being relatively inexpensive and providing good antimicrobial effects even in small amounts. In addition, since the organic antibacterial agents can cause discoloration after processing and cannot have long-term antibacterial persistence due to dissolution-related problems, the range of organic antibacterial agents applicable to an antibacterial thermoplastic resin composition is extremely limited.

Inorganic antibacterial agents are antibacterial agents containing metal components, such as silver (Ag) and copper (Cu), and are widely used in preparation of antibacterial thermoplastic resin compositions (antibacterial resins) due to good thermal stability thereof. However, since the inorganic antibacterial agents need to be used in large amounts due to lower antibacterial activity than the organic antibacterial agents and have disadvantages of relatively high price, difficulty in uniform dispersion upon processing, and discoloration due to the metal components, the inorganic antibacterial agents are used in a limited range of applications.

Therefore, there is a need for a thermoplastic resin composition which has good properties in terms of weather resistance (discoloration resistance), antibacterial effects, and antibacterial persistence while providing antifungal properties.

The background technique of the present invention is disclosed in Korean Patent No. 10-0696385 and the like.

### DISCLOSURE

### Technical Problem

It is one aspect of the present invention to provide a thermoplastic resin composition which has good weather resistance, antibacterial properties, and mechanical properties.

It is another aspect of the present invention to provide a molded product formed of the thermoplastic resin composition set forth above.

The above and other aspects of the present invention will become apparent from the detailed description of the following embodiments.

### Technical Solution

1. One aspect of the present invention relates to a thermoplastic resin composition. The thermoplastic resin composition includes: about 100 parts by weight of a thermoplastic resin including at least one of a polyamide resin and a polyester resin; and about 1 part by weight to about 5 parts by weight of zinc oxide, wherein the zinc oxide has an average particle diameter (D50) of about 0.8 μm to about 3 μm, as measured using a particle size analyzer, and a peak intensity ratio (B/A) of about 0.01 to about 1.0, where A indicates a peak in the wavelength range of 370 nm to 390 nm and B indicates a peak in the wavelength range of 450 nm to 600 nm in photoluminescence measurement.

2. In Embodiment 1, the polyamide resin may include an aliphatic polyamide resin, a semi-aromatic polyamide resin or a combination thereof.

3. In Embodiment 1 or 2, the polyester resin may include at least one of polyethylene terephthalate, polybutylene terephthalate, polyethylene naphthalate, polytrimethylene terephthalate, and polycyclohexylene terephthalate.

4. In Embodiments 1 to 3, the zinc oxide may have a peak position degree (2θ) in the range of about 35° to about 37° and a crystallite size of about 1,000 Å to about 2,000 Å in X-ray diffraction (XRD) analysis, as calculated by Equation 1:

$$Crystallite size ( D ) = \frac{Kλ}{βcosθ} \qquad [ Equation 1 ]$$

where K is a shape factor, λ is an X-ray wavelength, β is an FWHM value (degree) of an X-ray diffraction peak, and θ is a peak position degree.

5. In Embodiments 1 to 4, the zinc oxide may have a peak intensity ratio (B/A) of about 0.1 to about 1.0, where A indicates a peak in the wavelength range of 370 nm to 390 nm and B indicates a peak in the wavelength range of 450 nm to 600 nm in photoluminescence measurement.

6. In Embodiments 1 to 5, the zinc oxide may have an average particle diameter (D50) of about 1 μm to about 5 μm, as measured using a particle size analyzer.

7. In Embodiments 1 to 6, the zinc oxide may have a BET specific surface area of about 10 m²/g or less, as measured by a nitrogen gas adsorption method using a BET analyzer.

8. In Embodiments 1 to 7, the zinc oxide may have a BET specific surface area of about 1 m²/g to about 7 m²/g, as measured by a nitrogen gas adsorption method using a BET analyzer.

9. In Embodiments 1 to 8, the thermoplastic resin composition may have a color variation (ΔE) of about 2 to about 7, as calculated according to Equation 2 based on initial color values (L₀*, a₀*, b₀*) measured on an injection-molded specimen having a size of 50 mm×90 mm×2.5 mm using a colorimeter and color values (L₁*, a₁*, b₁*) of the specimen measured in the same manner as above after testing for 3,000 hours in accordance with ASTM D4459,

Color variation(ΔE)=\sqrt{(ΔL*)²+(Δa*)²+(Δb*)²} [Equation 2]

where ΔL* is a difference (L₁*−L₀*) between L* values before and after testing, Δa* is a difference (a₁*−a₀*) between a* values before and after testing, and Δb* is a difference (b₁*−b₀*) between b* values before and after testing.

10. In Embodiments 1 to 9, the thermoplastic resin composition may have an antibacterial activity of about 2 to about 7 against each of Staphylococcus aureus and Escherichia coli, as calculated according to Equation 3 after inoculation of 5 cm×5 cm specimens with Staphylococcus aureus and Escherichia coli, respectively, and culturing under conditions of 35° C. and 90% RH for 24 hours in accordance with JIS Z 2801,

Antibacterial activity=log(M1/M2) [Equation 3]

where M1 is the number of bacteria as measured on a blank specimen after culturing for 24 hours and M2 is the number of bacteria as measured on each of the specimens of the thermoplastic resin composition after culturing for 24 hours.

11. Another aspect of the present invention relates to a molded product. The molded product is formed of the thermoplastic resin composition according to any one of Embodiments 1 to 10.

12. In Embodiment 11, the molded product may include synthetic fibers.

### Advantageous Effects

The present invention provides a thermoplastic resin composition which has good weather resistance, antibacterial properties, and mechanical properties, and a molded product formed of the same.

### BEST MODE

Hereinafter, exemplary embodiments of the present invention will be described in detail.

A thermoplastic resin composition according to the present invention includes: (A) a thermoplastic resin; and (B) zinc oxide.

As used herein to represent a specific numerical range, the expression “a to b” means “≥a and ≤b”.

(A) Thermoplastic Resin

The thermoplastic resin according to the present invention may include (A1) a polyamide resin and/or (A2) a polyester resin.

(A1) Polyamide Resin

A polyamide resin according to one embodiment of the invention may be selected from among typical polyamide resins applicable to fibers.

In some embodiments, the polyamide resin may include: an aliphatic polyamide resin, such as polyamide 66, polyamide 6, and the like; a semi-aromatic polyamide resin obtained through polymerization of a dicarboxylic acid component including an aromatic dicarboxylic acid, such as polyamide 6T, and a diamine component including an aliphatic diamine; and combinations thereof.

In some embodiments, the polyamide resin may have an intrinsic viscosity (IV) of about 0.88 dL/g to about 1.3 dL/g, for example, about 0.9 dL/g to about 1.1 dL/g, as measured in a sulfuric acid solution (concentration: 98%) at 35° C. using an Ubbelohde viscometer. Within this range, the thermoplastic resin composition has good mechanical properties and may be suitable for synthetic fibers.

(A2) Polyester Resin

According to one embodiment of the invention, the polyamide resin may be selected from typical polyester resins applicable to fibers. For example, the polyester resin may be obtained through polycondensation of a dicarboxylic acid component, for example, an aromatic dicarboxylic acid, such as terephthalic acid (TPA), isophthalic acid (IPA), 1,2-naphthalene dicarboxylic acid, 1,4-naphthalene dicarboxylic acid, 1,5-naphthalene dicarboxylic acid, 1,6-naphthalene dicarboxylic acid, 1,7-naphthalene dicarboxylic acid, 1,8-naphthalene dicarboxylic acid, 2,3-naphthalene dicarboxylic acid, 2,6-naphthalene dicarboxylic acid, 2,7-naphthalenedicarboxylic acid, and the like, and an aromatic dicarboxylate, such as dimethyl terephthalate (DMT), dimethyl isophthalate, dimethyl-1,2-naphthalate, dimethyl-1,5-naphthalate, dimethyl-1,7-naphthalate, dimethyl-1,7-naphthalate, dimethyl-1,8-naphthalate, dimethyl-2,3-naphthalate, dimethyl-2,6-naphthalate, dimethyl-2,7-naphthalate, and the like, with a diol component, such as ethylene glycol, 1,2-propylene glycol, 1,3-propylene glycol, 2,2-dimethyl-1,3-propane diol, 1,3-butane diol, 1,4-butane diol, 1,5-pentane diol, 1,5-pentane diol, 1,6-hexane diol, and the like.

In some embodiments, the polyester resin may include at least one of polyethylene terephthalate (PET), polybutylene terephthalate (PBT), polyethylene naphthalate (PEN), and polytrimethylene terephthalate (PTT).

In some embodiments, the polyester resin may have an intrinsic viscosity (IV) of about 1.18 dL/g to about 1.22 dL/g, as measured in an o-chlorophenol solution (concentration: 0.5 g/dl) at 35° C. Within this range, the thermoplastic resin composition has good mechanical properties and may be suitable for synthetic fibers.

The thermoplastic resin according to the embodiment may include the polyamide resin or the polyester resin alone, or may include a combination thereof. In the combination, the polyamide resin and the polyester resin may be present in a weight ratio of about 1:99 to about 99:1.

(B) Zinc Oxide

The zinc oxide according to the present invention serves to improve weather resistance and antibacterial properties of the thermoplastic resin composition, and may have a peak intensity ratio (B/A) of about 0.01 to about 1.0, for example, about 0.1 to about 1.0, specifically about 0.2 to about 0.7, where A indicates a peak in the wavelength range of 370 nm to 390 nm and B indicates a peak in the wavelength range of 450 nm to 600 nm in photoluminescence measurement. If the peak intensity ratio (B/A) of the zinc oxide is less than about 0.01, the thermoplastic resin composition can have poor antibacterial properties. If the peak intensity ratio (B/A) of the zinc oxide exceeds about 1.0, there can be a problem of initial discoloration of the thermoplastic resin and the thermoplastic resin composition can suffer from deterioration in weather resistance and the like.

In some embodiments, the zinc oxide may have various shapes, for example, a spherical shape, a plate shape, a rod shape, and combinations thereof. In addition, the zinc oxide may have an average particle diameter (D50) of about 0.8 μm to about 3 μm, for example, about 1 μm to about 3 μm, as measured in a single particle state (not forming a secondary particle through agglomeration of particles) using a particle size analyzer (Laser Diffraction Particle Size Analyzer LS I3 320, Beckman Coulter Co., Ltd.). If the average particle diameter (D50) of the zinc oxide is less than about 0.8 μm, the thermoplastic resin composition can suffer from deterioration in discoloration resistance (weather resistance) and the like, and if the average particle diameter (D50) of the zinc oxide exceeds about 3 μm, the thermoplastic resin composition can suffer from deterioration in impact resistance and the like.

In some embodiments, the zinc oxide may have a peak position degree (2θ) in the range of about 35° to about 37° and a crystallite size of about 1,000 Å to about 2,000 Å, for example, about 1,200 Å to about 1,800 Å, in X-ray diffraction (XRD) analysis, as calculated by Scherrer's equation (Equation 1) with reference to a measured FWHM value (full width at half maximum of a diffraction peak). Within this range, the thermoplastic resin composition can have good initial color, weather resistance (discoloration resistance), antibacterial properties, and balance between mechanical properties.

$$Crystallite size ( D ) = \frac{Kλ}{βcosθ} \qquad < Equation 1 >$$

where K is a shape factor, λ is an X-ray wavelength, β is an FWHM value (degree) of an X-ray diffraction peak, and θ is a peak position degree.

In some embodiments, the zinc oxide may have a BET specific surface area of about 10 m²/g or less, for example, about 1 m²/g to about 7 m²/g, as measured by a nitrogen gas adsorption method using a BET analyzer (Surface Area and Porosity Analyzer ASAP 2020, Micromeritics Co., Ltd.), and a purity of about 99% or more. Within this range, the thermoplastic resin composition can have good discoloration resistance and mechanical properties.

In some embodiments, the zinc oxide may be prepared by melting metallic zinc in a reactor, heating the molten zinc to about 850° C. to about 1,000° C., for example, about 900° C. to about 950° C., to vaporize the molten zinc, injecting oxygen gas into the reactor, cooling the reactor to about 20° C. to about 30° C., and heating the reactor to about 400° C. to about 900° C., for example, 500° C. to about 800° C., for about 30 minutes to about 150 minutes, for example, about 60 minutes to about 120 minutes.

In some embodiments, the zinc oxide may be present in an amount of about 1 part by weight to about 5 parts by weight, for example, about 2 parts by weight to about 4 parts by weight, relative to about 100 parts by weight of the rubber-modified aromatic vinyl copolymer resin. If the amount of the zinc oxide is less than about 1 part by weight relative to about 100 parts by weight of the rubber-modified aromatic vinyl copolymer resin, the thermoplastic resin composition can have poor weather resistance and antibacterial properties. If the amount of the zinc oxide exceeds about 5 parts by weight, the thermoplastic resin composition can have poor mechanical properties.

The thermoplastic resin composition according to one embodiment of the invention may further include additives used in typical thermoplastic resin compositions. Examples of the additives may include flame retardants, fillers, antioxidants, anti-dripping agents, lubricants, release agents, nucleating agents, antistatic agents, pigments, dyes, and combinations thereof, without being limited thereto. The additives may be present in an amount of about 0.001 parts by weight to about 40 parts by weight, for example, about 0.1 parts by weight to about 10 parts by weight, relative to about 100 parts by weight of the thermoplastic resin.

The thermoplastic resin composition according to the present invention may be prepared in pellet form by mixing the aforementioned components, followed by melt extrusion in a typical twin-screw extruder at about 200° C. to about 280° C., for example, about 220° C. to about 250° C.

In some embodiments, the thermoplastic resin composition may have a color variation (ΔE) of about 2 to about 7, for example, about 3 to about 6, as calculated according to Equation 2 based on initial color values (L₀*, a₀*, b₀*) measured on an injection-molded specimen having a size of 50 mm×90 mm×2.5 mm using a colorimeter and color values (L₁*, a₁*, b₁*) of the specimen measured in the same manner as above after testing for 3,000 hours in accordance with ASTM D4459.

Color variation(ΔE)=\sqrt{(ΔL*)²+(Δa*)²+(Δb*)²} [Equation 2]

where ΔL* is a difference (L₁*−L₀*) between L* values before and after testing, Δa* is a difference (a₁*−a₀*) between a* values before and after testing, and Δb* is a difference (b₁*−b₀*) between b* values before and after testing.

In some embodiments, the thermoplastic resin composition has an antibacterial effect against various bacteria, such as Staphylococcus aureus, Escherichia coli, Bacillus subtilis, Pseudomonas aeruginosa, Salmonella, Pneumococcus, and methicillin-resistant Staphylococcus Aureus (MRSA), and may have an antibacterial activity of about 2 to about 7, for example, about 2 to about 5, against each of Staphylococcus aureus and Escherichia coli, as calculated according to Equation 3 after inoculation of 5 cm×5 cm specimens with Staphylococcus aureus and Escherichia coli, respectively, and culturing under conditions of 35° C. and 90% RH for 24 hours in accordance with JIS Z 2801.

Antibacterial activity=log(M1/M2) [Equation 3]

where M1 is the number of bacteria as measured on a blank specimen after culturing for 24 hours and M2 is the number of bacteria as measured on each of the specimens of the thermoplastic resin composition after culturing for 24 hours.

Here, the “blank specimen” refers to a control specimen for comparison with a test specimen (specimen of the thermoplastic resin composition). Specifically, the blank specimen is prepared by inoculating an empty petri dish, which is suitable for checking whether the inoculated bacteria grow normally, with bacteria, followed by culturing for 24 hours under the same conditions as the test specimen. Antibacterial performance of the test specimen is evaluated based on comparison of the number of cultured bacteria between the blank specimen and the test specimen. Here, the “number of cultured bacteria” may be determined through a process in which each specimen is inoculated with the bacteria, followed by culturing for 24 hours, and then an inoculation solution of the bacteria is recovered and diluted, followed by growing the bacteria into a colony on a culture dish. When population of the colony is too large to count, the number of cultured bacteria may be determined by dividing the colony divided into multiple sectors, measuring the population size of one sector, and converting the measured value into total population.

A molded product according to the present invention is formed of the thermoplastic resin composition set forth above. The thermoplastic resin composition may be prepared in pellet form. The prepared pellets may be produced into various molded products (articles) by various molding methods, such as injection molding, extrusion, vacuum molding, and casting. These molding methods are well known to those skilled in the art. The molded product has good weather resistance, antibacterial properties, mechanical properties, and balance therebetween and thus can be advantageously used as antibacterial products, particularly, antibacterial synthetic fibers, which are frequently touched by the human body and thus require antibacterial properties.

### MODE FOR INVENTION

Next, the present invention will be described in more detail with reference to some examples. It should be understood that these examples are provided for illustration only and are not to be in any way construed as limiting the invention.

### Example

Details of components used in Examples and Comparative Examples are as follows:

(A) Thermoplastic Resin

(A1) Polyamide Resin

Polyamide 66 (Manufacturer: Rhodia Co., Ltd., Product Name: STABAMID 23AE1K) was used.

(A2) Polyester Resin

Polybutylene terephthalate (PBT, Manufacturer: Shinkong Synthetic Fibers Co., Product Name: SHINITE® PBTD201) was used.

(B) Zinc Oxide

(B1) Metallic zinc was melted in a reactor, followed by heating to 900° C. to vaporize the molten zinc, and then oxygen gas was injected into the reactor, followed by cooling to room temperature (25° C.) to obtain an intermediate. Then, the intermediate was subjected to heat treatment at 750° C. for 90 minutes, followed by cooling to room temperature (25° C.), thereby preparing zinc oxide.

(B2) Zinc oxide (Manufacturer: Ristecbiz Co., Ltd., product name: RZ-950) was used.

(B3) Zinc oxide (Manufacture: Hanil Chemical Ind Co., Ltd., product name: TE30) was used.

For each of the zinc oxides B1, B2, B3, average particle diameter, BET surface area, purity, peak intensity ratio (B/A) of peak B in the wavelength range of 450 nm to 600 nm to peak A in the wavelength range of 370 nm to 390 nm in photoluminescence measurement, and crystallite size were measured. Results are shown in Table 1.

TABLE 1

| | (B1) | (B2) | (B3) |
|---|---|---|---|
| Average particle diameter (μm) | 1.2 | 0.890 | 3.7 |
| BET surface area (m²/g) | 4 | 15 | 14 |
| Purity (%) | 99 | 97 | 97 |
| PL peak intensity ratio (B/A) | 0.28 | 9.8 | 9.5 |
| Crystallite size (Å) | 1417 | 503 | 489 |

Property Evaluation

(1) Average particle diameter (unit: μm): Average particle diameter (volume average) was measured using a particle size analyzer (Laser Diffraction Particle Size Analyzer LS I3 320, Beckman Coulter Co., Ltd.).

(2) BET surface area (unit: m²/g): BET surface area was measured by a nitrogen gas adsorption method using a BET analyzer (Surface Area and Porosity Analyzer ASAP 2020, Micromeritics Co., Ltd.).

(3) Purity (unit: %): Purity was measured by thermogravimetric analysis (TGA) based on the weight of remaining material at 800° C.

(4) PL peak intensity ratio (B/A): Spectrum emitted upon irradiation of a specimen using a He—Cd laser (KIMMON, 30 mW) at a wavelength of 325 nm at room temperature was detected by a CCD detector in a photoluminescence measurement method, in which the CCD detector was maintained at −70° C. A peak intensity ratio (B/A) of peak B in the wavelength range of 450 nm to 600 nm to peak A in the wavelength range of 370 nm to 390 nm was measured. Here, an injection molded specimen was irradiated with laser beams without separate treatment upon PL analysis, and zinc oxide powder was compressed in a pelletizer having a diameter of 6 mm to prepare a flat specimen.

(5) Crystallite size (unit: Å): Crystallite size was measured using a high-resolution X-ray diffractometer (PRO-MRD, X'pert Inc.) at a peak position degree (2θ) in the range of 35° to 37° and calculated by Scherrer's equation (Equation 1) with reference to a measured FWHM value (full width at half maximum of a diffraction peak). Here, both a powder form and an injection molded specimen could be measured. For more accurate analysis, the injection molded specimen was subjected to heat treatment in air at 600° C. for 2 hours to remove a polymer resin therefrom before XRD analysis.

$$Crystallite size ( D ) = \frac{Kλ}{βcosθ} \qquad [ Equation 1 ]$$

where K is a shape factor, λ is an X-ray wavelength, β is an FWHM value (degree) of an X-ray diffraction peak, and θ is a peak position degree.

### Examples 1 to 4 and Comparative Examples 1 to 8

The aforementioned components were mixed in amounts as listed in Tables 2 and 3, followed by extrusion at 230° C., thereby preparing a thermoplastic resin composition in pellet form. Here, extrusion was performed using a twin-screw extruder (L/D: 36, Φ: 45 mm). The prepared pellets were dried at 80° C. for 4 hours or more and then subjected to injection molding using a 6 oz. injection machine (molding temperature: 230° C., mold temperature: 60° C.), thereby preparing a specimen. The prepared specimen was evaluated as to the following properties. Results are shown in Tables 2 and 3.

Property Evaluation

(1) Weather resistance (color variation (ΔE)): For determination of color variation, initial color values L₀*, a₀*, b₀* were measured on an injection molded specimen having a size of 50 mm×90 mm×2.5 mm using a colorimeter (KONICA MINOLTA, CM-3700A), followed by testing for 3,000 hours in accordance with ASTM D4459, and then color values L₁*, a₁*, b₁* of the specimen were measured in the same manner as above. Thereafter, color variation (ΔE) was calculated according to Equation 2:

Color variation(ΔE)=\sqrt{(ΔL*)²+(Δa*)²+(Δb*)²} [Equation 2]

where ΔL* is a difference (L₁*−L₀*) between L* values before and after testing, Δa* is a difference (a₁*−a₀*) between a* values before and after testing, and Δb* is a difference (b₁*−b₀*) between b* values before and after testing.

(2) Antibacterial activity: In accordance with JIS Z 2801, 5 cm×5 cm specimens were inoculated with Staphylococcus aureus and Escherichia coli, respectively, and subjected to culturing under conditions of 35° C. and 90% RH for 24 hours, followed by calculation of antibacterial activity according to Equation 3:

Antibacterial activity=log(M1/M2) [Equation 3]

where M1 is the number of bacteria as measured on a blank specimen after culturing for 24 hours and M2 is the number of bacteria as measured on each of the specimens after culturing for 24 hours.

(3) Notched Izod impact strength (unit: kgf·cm/cm): Notched Izod impact strength was measured on a ⅛″ thick Izod specimen in accordance with ASTM D256.

TABLE 2

Example

| | 1 | 2 | 3 | 4 |
|---|---|---|---|---|
| (A1) (parts by weight) | 100 | 100 | — | — |
| (A2) (parts by weight) | — | — | 100 | 100 |
| (B1) (parts by weight) | 2 | 4 | 2 | 4 |
| (B2) (parts by weight) | — | — | — | — |
| (B3) (parts by weight) | — | — | — | — |
| Weather resistance (ΔE) | 5.2 | 3.6 | 5.5 | 3.9 |
| Antibacterial activity | 6.3 | 6.2 | 6.1 | 6.3 |
| (Escherichia coli) | | | | |
| Antibacterial activity | 4.6 | 4.6 | 4.6 | 4.6 |
| (Staphylococcus aureus) | | | | |
| Notched Izod impact | 3.1 | 2.7 | 3.5 | 3.0 |
| strength | | | | |

TABLE 3

| | Comparative Example | | | | | | | |
|---|---|---|---|---|---|---|---|---|
| | 1 | 2 | 3 | 4 | 5 | 6 | 7 | 8 |
| (A1) (parts by weight) | 100 | 100 | 100 | 100 | — | — | — | — |
| (A2) (parts by weight) | — | — | — | — | 100 | 100 | 100 | 100 |
| (B1) (parts by weight) | 0.5 | 6 | — | — | 0.5 | 6 | — | — |
| (B2) (parts by weight) | — | — | 2 | 4 | — | — | — | — |
| (B3) (parts by weight) | — | — | — | — | — | — | 2 | 4 |
| Weather resistance (ΔE) | 7.2 | 2.5 | 7.6 | 8.2 | 7.5 | 2.6 | 8.4 | 9.6 |
| Antibacterial activity | 1.2 | 6.2 | 6.1 | 6.3 | 0.8 | 6.3 | 6.1 | 6.2 |
| (Escherichia coli) | | | | | | | | |
| Antibacterial activity | 0.8 | 4.6 | 4.6 | 4.6 | 0.6 | 4.6 | 4.6 | 4.6 |
| (Staphylococcus aureus) | | | | | | | | |
| Notched Izod impact | 3.2 | 1.8 | 2.1 | 1.6 | 3.8 | 2.0 | 2.2 | 1.8 |
| strength | | | | | | | | |

From the above results, it could be seen that the thermoplastic resin compositions according to the present invention had good weather resistance (color variation (ΔE)), antibacterial properties (antibacterial activity), mechanical properties (notched Izod impact strength), and the like.

Conversely, it could be seen that the thermoplastic resin compositions of Comparative Examples 1 and 5 each prepared using an insufficient amount of the zinc oxide suffered from deterioration in antibacterial properties, weather resistance, and the like; the thermoplastic resin compositions of Comparative Examples 2 and 6 each prepared using an excess of the zinc oxide suffered from deterioration in mechanical properties (impact resistance) and the like; the thermoplastic resin compositions of Comparative Examples 3 and 4 each prepared using zinc oxide B2 suffered from deterioration in weather resistance and mechanical properties; and the thermoplastic resin compositions of Comparative Examples 7 and 8 each prepared using zinc oxide B3 also suffered from deterioration in weather resistance and mechanical properties.

It should be understood that various modifications, changes, alterations, and equivalent embodiments can be made by those skilled in the art without departing from the spirit and scope of the invention.

1. A thermoplastic resin composition comprising:
about 100 parts by weight of a thermoplastic resin comprising a polyamide resin and/or a polyester resin; and
about 1 part by weight to about 5 parts by weight of zinc oxide,
wherein the zinc oxide has an average particle diameter (D50) of about 0.8 μm to about 3 μm, as measured using a particle size analyzer, and a peak intensity ratio (B/A) of about 0.01 to about 1.0, where A indicates a peak in the wavelength range of 370 nm to 390 nm and B indicates a peak in the wavelength range of 450 nm to 600 nm in photoluminescence measurement.

2. The thermoplastic resin composition according to claim 1, wherein the polyamide resin comprises an aliphatic polyamide resin, a semi-aromatic polyamide resin, or a combination thereof.

3. The thermoplastic resin composition according to claim 1, wherein the polyester resin comprises polyethylene terephthalate, polybutylene terephthalate, polyethylene naphthalate, polytrimethylene terephthalate, and/or polycyclohexylene terephthalate.

4. The thermoplastic resin composition according to claim 1, wherein the zinc oxide has a peak position degree (2θ) in the range of about 35° to about 37° and a crystallite size of about 1,000 Å to about 2,000 Å in X-ray diffraction (XRD) analysis, as calculated by Equation 1:
$$Crystallite size ( D ) = \frac{Kλ}{βcosθ} \qquad [ Equation 1 ]$$
where K is a shape factor, λ is an X-ray wavelength, β is an FWHM value (degree) of an X-ray diffraction peak, and θ is a peak position degree.

5. The thermoplastic resin composition according to claim 1, to wherein the zinc oxide has a peak intensity ratio (B/A) of about 0.1 to about 1.0, where A indicates a peak in the wavelength range of 370 nm to 390 nm and B indicates a peak in the wavelength range of 450 nm to 600 nm in photoluminescence measurement.

6. The thermoplastic resin composition according to claim 1, wherein the zinc oxide has an average particle diameter (D50) of about 1 μm to about 5 μm, as measured using a particle size analyzer.

7. The thermoplastic resin composition according to claim 1, wherein the zinc oxide has a BET specific surface area of about 10 m²/g or less, as measured by a nitrogen gas adsorption method using a BET analyzer.

8. The thermoplastic resin composition according to claim 1, wherein the zinc oxide has a BET specific surface area of about 1 m²/g to about 7 m²/g, as measured by a nitrogen gas adsorption method using a BET analyzer.

9. The thermoplastic resin composition according to claim 1, wherein the thermoplastic resin composition has a color variation (ΔE) of about 2 to about 7, as calculated according to Equation 2 based on initial color values (L₀*, a₀*, b₀*) measured on an injection-molded specimen having a size of 50 mm×90 mm×2.5 mm using a colorimeter and color values (L₁*, a₁*, b₁*) of the specimen measured in the same manner as above after testing for 1,500 hours in accordance with ASTM D4459,
Color variation(ΔE)=\sqrt{(ΔL*)²+(Δa*)²+(Δb*)²} [Equation 2]
where ΔL* is a difference (L₁*−L₀*) between L* values before and after testing, Δa* is a difference (a₁*−a₀*) between a* values before and after testing, and Δb* is a difference (b₁*−b₀*) between b* values before and after testing.

10. The thermoplastic resin composition according to claim 1, wherein the thermoplastic resin composition has an antibacterial activity of about 2 to about 7 against each of Staphylococcus aureus and Escherichia coli, as calculated according to Equation 3 after inoculation of 5 cm×5 cm specimens with Staphylococcus aureus and Escherichia coli, respectively, and culturing under conditions of 35° C. and 90% RH for 24 hours in accordance with JIS Z 2801,
Antibacterial activity=log(M1/M2) [Equation 3]
where M1 is the number of bacteria as measured on a blank specimen after culturing for 24 hours and M2 is the number of bacteria as measured on each of the specimens of the thermoplastic resin composition after culturing for 24 hours.

11. A molded product formed of the thermoplastic resin composition according to claim 1.

12. The molded product according to claim 11, wherein the molded product comprises synthetic fibers.
